(19) United States
(12) Patent Application Publication
(10) Pub. No.: US 2026/0360645 A1
(43) Pub. Date: Nov. 12, 2026

(54) RELAY HEAT DISSIPATION STRUCTURE

(71) Applicant: Sung-Jen Wu, New Taipei City (TW)

(72) Inventor: Sung-Jen Wu, New Taipei City (TW)

(21) Appl. No.: 19/200,708

(22) Filed: May 7, 2025

(51) Int. Cl. H01H 50/12; H01H 50/02

(52) U.S. Cl. CPC H01H 50/12; H01H 50/02

(57) ABSTRACT

The present invention relates to a relay heat dissipation structure, which includes: an outer cover with a receiving groove recessed from one side and having a receiving opening; and a base installed on the side of the outer cover with the receiving opening. A flow-guiding portion is provided on the outer cover's surface with at least one air convection hole extending toward and communicating with the receiving groove. A magnetic-electric control component is installed on the base's side facing the receiving groove. The flow-guiding portion allows heat generated by the magnetic-electric control component within the receiving groove to circulate via the air convection hole, helping to maintain operational yield and address issues such as shortened service life due to high temperatures. It also prevents problems like poor conductivity or poor contact caused by moisture freezing on the components.

### FIELD OF THE INVENTION

The present invention relates to a relay heat dissipation structure and, more particularly, to technologies applied in the field of electromechanics.

### BACKGROUND OF THE INVENTION

Relays are used in a wide range of applications, such as low-current relays available in distribution boxes and control boxes, and high-current (automatic) relays applied in large manufacturing facilities and vehicles. These relays primarily serve to match and regulate the high current transmission required by large machinery in vehicles and large manufacturing facilities. However, high-current relays used in many facilities and vehicles are often exposed to outdoor conditions for extended periods, including while driving or when parked in parking lots or roadside spaces. As a result, the relays are often exposed to harsh external environments such as intense heat from sunlight, dust contamination, and rain. This frequent exposure to external environments leads to moisture accumulating inside the relays, potentially freezing, or dust and grime entering the interior, thereby causing issues such as poor contact or failure in current conduction between internal components.

In addition, high-current relays generate significant heat due to prolonged operation. This high temperature undoubtedly shortens the lifespan of the internal electronic components. Furthermore, most relays are encapsulated and lack mechanisms for temperature regulation or heat dissipation. Consequently, relays are among the most frequently replaced electronic components. In view of these issues, the inventor of this application, based on years of practical experience in the industry, conducted research and development on the structural integration of related components to address the drawbacks of conventional technologies. As a result, a “relay heat dissipation structure” has been developed that not only effectively regulates internal temperature but also efficiently blocks external moisture and dust, meeting environmental usage requirements and making it a highly practical solution for relays.

### SUMMARY OF THE INVENTION

The primary objective of the present invention is to enable efficient transfer and circulation of heat generated internally during high-current operation to the external environment. This effectively lowers the internal temperature of the relay, thereby preserving the functionality of its internal components. Additionally, it prevents external contaminants such as water and dust from entering the relay, ensuring stable operation. The present invention addresses the shortcomings of conventional relays, where heat generated inside can expose components to high temperatures, resulting in reduced lifespan. Furthermore, environmental factors can introduce moisture inside the relay, which may freeze in low-temperature conditions, leading to poor contact or failure in current conduction among internal components.

To achieve the aforementioned objectives and overcome the shortcomings of conventional technology, the relay heat dissipation structure of the present invention includes: an outer cover with a receiving groove which is recessed from one side thereof and has a receiving opening, wherein any portion on a surface the outer cover is provided with a flow-guiding portion that has at least one air convection hole extending therethrough, directed toward the receiving groove, and communicating with the receiving groove; and a base, installed on the side of the outer cover having the receiving opening, wherein a magnetic-electric control component is further installed on a side of the base facing the receiving groove; wherein the flow-guiding portion is configured to allow heat generated by the magnetic-electric control component located within the receiving groove to circulate via the at least one air convection hole, thereby maintaining an operational yield of the magnetic-electric control component.

### BRIEF DESCRIPTION OF THE DRAWINGS

FIG. 1 shows a perspective schematic view of the present invention.

FIG. 2 shows another perspective schematic view of the present invention from a different angle.

FIG. 3 shows yet another perspective schematic view of the present invention from a different angle.

FIG. 4 shows an exploded perspective schematic view of the present invention.

FIG. 5 shows another exploded perspective schematic view of the present invention from a different angle.

FIG. 6 shows a cross-sectional schematic view along line VI-VI of FIG. 1.

FIG. 7 shows a cross-sectional schematic view along line VII-VII of FIG. 1.

FIG. 8 shows a perspective schematic view of another embodiment of the annular rib of the present invention.

FIG. 9 shows an enlarged partial schematic view of FIG. 8.

FIG. 10 shows a cross-sectional schematic view along line IX-IX of FIG. 8.

FIG. 11 shows a cross-sectional schematic view along line XI-CI of FIG. 2.

FIG. 12 shows an enlarged partial schematic view of FIG. 11.

FIG. 13 shows a perspective schematic view of another embodiment of the bottom cover.

FIG. 14 shows an enlarged partial schematic view of FIG. 13.

### DETAILED DESCRIPTION OF THE PREFERRED EMBODIMENT

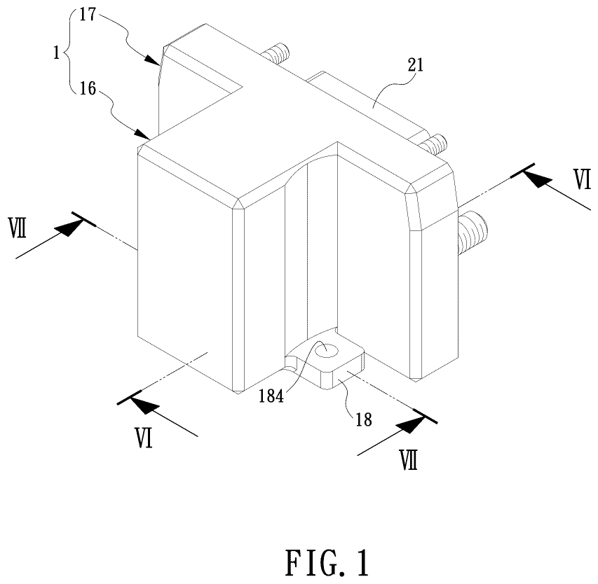

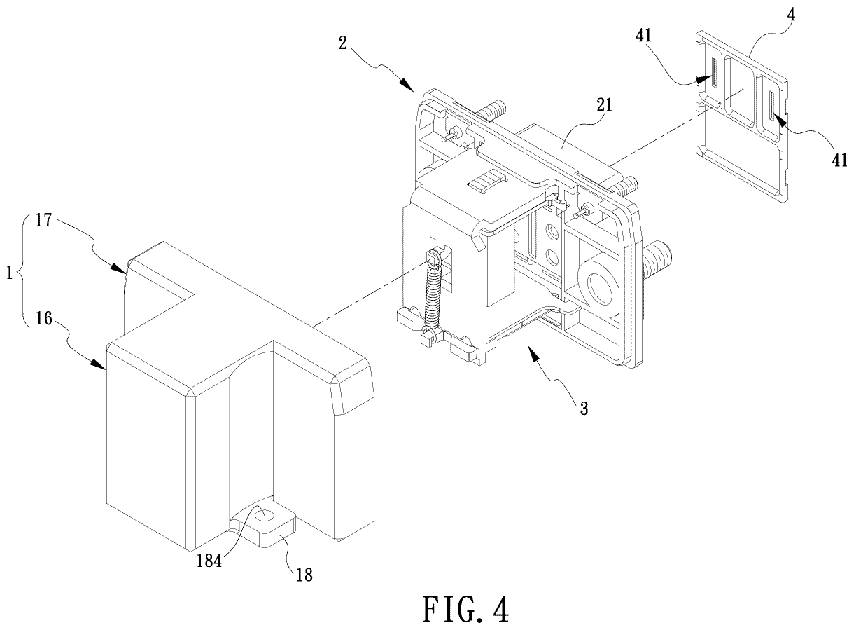

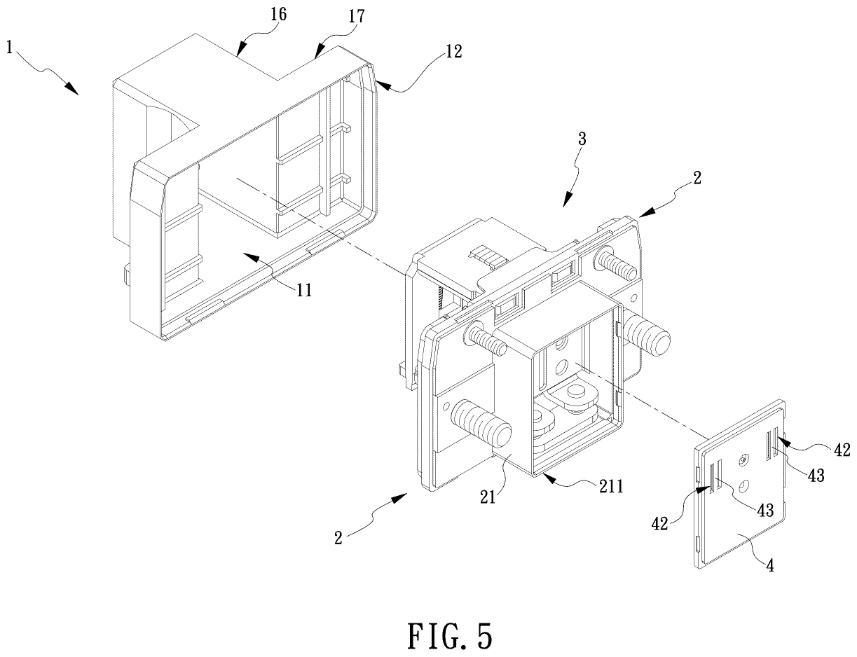

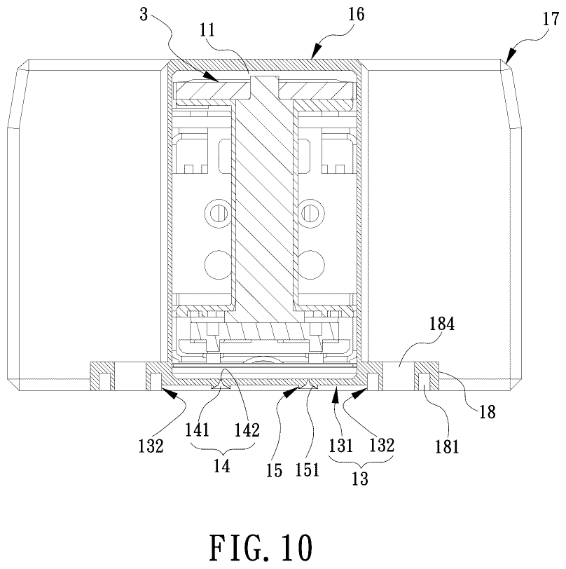

As shown in FIGS. 1 to 14, the present invention provides a relay heat dissipation structure, including an outer cover 1 with a receiving groove 11 which is recessed from one side thereof and has a receiving opening 12. The receiving groove 11 is T-shaped. A flow-guiding portion 13 is further provided at any portion on the surface of the outer cover 1. To accommodate different designs of the outer covers 1 for various relays, the positioning of the flow-guiding portion 13 is not restricted to a specific location on the outer cover 1. In the drawings of this application, the flow-guiding portion 13 is mainly illustrated as being on the bottom surface of the outer cover 1. The flow-guiding portion 13 is provided with at least one air convection hole 14 extending therethrough, directed toward the receiving groove 11, such that the air convection hole 14 communicates with the receiving groove 11. This allows convection and conduction between air inside the receiving groove 11 and the outside air. The relay heat dissipation structure further includes a base 2 installed on the side of the outer cover 1 with the receiving opening 12 to seal the receiving groove 11. A magnetic-electric control component 3 is further installed on the side of the base 2 facing the receiving groove 11 and primarily used for regulating high current. The internal structure of the magnetic-electric control component 3 consists of conventional relay components and is therefore not described in detail here. By incorporating the flow-guiding portion 13, when the relay heat dissipation structure of the present invention is installed in a relevant facility, with the side having the flow-guiding portion 13 in contact with the mounting location, heat generated by the magnetic-electric control component 3 in the receiving groove 11 can circulate through the at least one air convection hole 14, thereby maintaining the operational stability of the magnetic-electric control component 3.

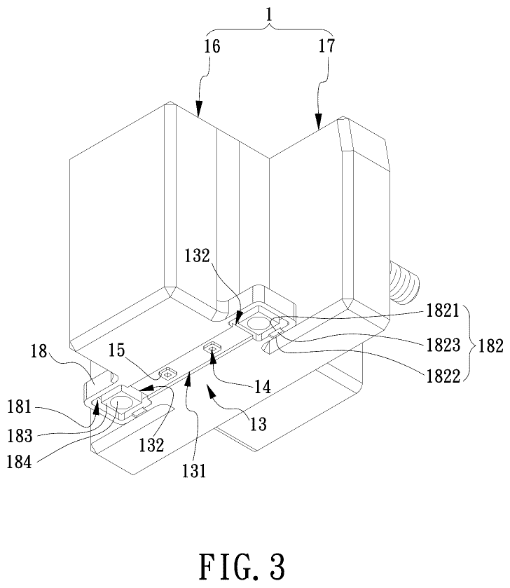

According to the technical features defined above, and as shown in FIGS. 3, 6, and 7, when the relay is installed on electrical equipment and in operation, the magnetic-electric control component 3 will generate heat over time. Traditional relays, due to their electronic components being enclosed within a housing and lacking sufficient ventilation holes, tend to accumulate heat internally. Prolonged exposure to high temperatures can degrade operational performance and shorten the lifespan of the electronic components. Moreover, if a conventional relay is placed in a low-temperature environment, moisture may accumulate inside and freeze, resulting in poor contact between internal electronic components and reduced conductivity. In contrast, the present invention includes at least one air convection hole 14, which enables air circulation within the receiving groove 11, thereby preventing moisture buildup and avoiding internal freezing. Additionally, this configuration allows the temperature inside the receiving groove 11 to be balanced with external temperature via convection, enabling the magnetic-electric control component 3 to operate over extended periods at an optimal temperature, thereby ensuring good conductivity of all its electronic parts.

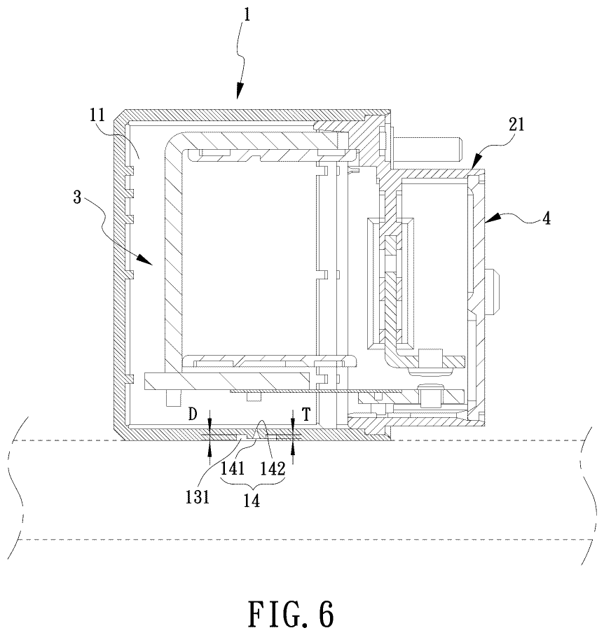

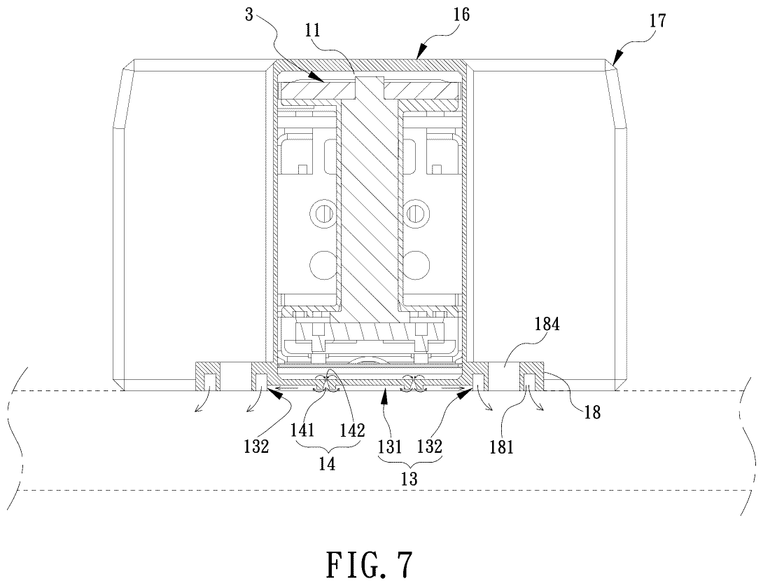

Other technical features of the present invention are described in detail below. First, for the flow-guiding portion 13 on the outer cover 1, a recessed design is adopted to facilitate smooth airflow and effective convection of the heat from within the receiving groove 11. To this end, an air guide groove 131 is formed on any side of the outer cover 1 and recessed toward the receiving groove 11. In the drawings, the air guide groove 131 is shown as an elongated groove formed on the bottom end of the outer cover 1. As can be seen, the at least one air convection hole 14 extends through the bottom surface of the air guide groove 131 and communicates with the receiving groove 11. In addition, a pair of openings 132 are formed at both ends of the air guide groove 131, respectively, allowing the groove space of the air guide groove 131 to be open. Therefore, when the relay heat dissipation structure of the present invention is installed in a relevant facility, with the side having the air guide groove 131 attached to a panel, heat generated inside the receiving groove 11 during operation can be expelled through the air convection hole 14, flow through the air guide groove 131, and exit through the pair of openings 132 on both sides of the air guide groove 131, facilitating heat exchange with external air via circulation and convection. Through the combination of the air guide groove 131 and the pair of openings 132, the air guide groove 131 functions as an air passageway, regulating and circulating internal and external temperatures. This achieves a balance between the internal temperature of the receiving groove 11 and the external environment. Please refer to FIGS. 1 to 7, where the dashed lines in FIGS. 6 and 7 indicate an installation location, such as a terminal base, panel or the like.

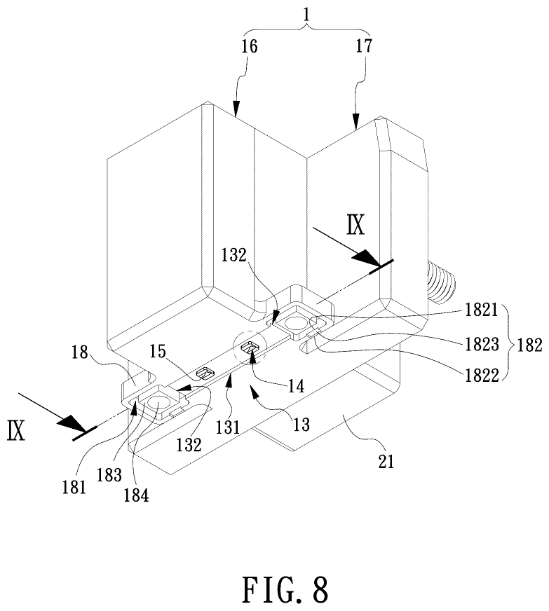

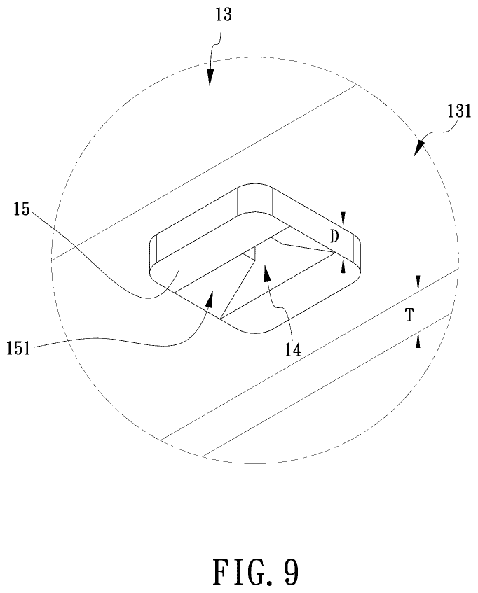

As shown in FIGS. 3 and 5 to 7, the installation of the relay of the present invention commonly involves attaching the side having the flow-guiding portion 13 against the control panel or a dedicated terminal base for plug-in relays. In order to prevent poor circulation and heat transfer between the high temperature inside the receiving groove 11 and the outside, in addition to the design of the pair of openings 132 as previously described, an annular rib 15 is further provided and protrudes from the bottom surface of the air guide groove 131, corresponding to the location of the at least one air convection hole 14. The annular rib 15 is arranged to surround the opening of the at least one air convection hole 14 and configured into two different structural forms. First, in the embodiment shown in FIG. 3, the groove height of the air guide groove 131 is defined as a height (T), and the thickness of the annular rib 15 is defined as a height (D), with the height (T)>the height (D). Thereby, when the high temperature in the receiving groove 11 is discharged through the at least one air convection hole 14, the temperature, due to the previously mentioned height difference, dissipates into the air guide groove 131 and is guided out through the pair of openings 132. Further, another embodiment of the annular rib 15 is shown in FIGS. 8 and 9. When the height (T)=the height (D), in order to prevent the outer surface of the annular rib 15 from obstructing the high temperature being guided out through the air convection hole 14, a side guide groove 151 is further recessed in a portion of the annular rib 15. The side guide groove 151 connects at one end to the at least one air convection hole 14, and the other end connects to the groove space of the air guide groove 131, thereby maintaining the connectivity between the at least one air convection hole 14 and the air guide groove 131. As such, the high temperature inside the receiving groove 11 can be discharged through the at least one air convection hole 14, guided into the air guide groove 131 via the side guide groove 151 and then expelled through the pair of openings 132. Additionally, the bottom surface of the side guide groove 151 can be an inclined surface. For the side guide groove 151, the variance in opening diameters between the end connected to the at least one air convection hole 14 and the other end connected to the air guide groove 131 is not restricted, as long as the heat in the receiving groove 11 can be dissipated. This is not limited to the illustration in the drawings.

The above description illustrates the air guiding technology. The following explains the arrangement of the air convection hole 14.

The above description is for illustration of the air guiding technology. The following describes the arrangement of the at least one air convection hole 14. To prevent external foreign objects from entering the receiving groove 11 through the at least one air convection hole 14, a first opening end 141 is defined in the design of the at least one air convection hole 14, and a second opening end 142 is defined at an opposite end of the at least one air convection hole 14 from the first opening end 141. The aperture of the second opening end 142 is smaller than that of the first opening end 141. The inner bore of the at least one air convection hole 14 tapers from the first opening end 141 toward the second opening end 142, forming a conical shape, as shown in FIG. 6. Through this tapered configuration of the at least one air convection hole 14, external foreign objects cannot enter the interior of the receiving groove 11 through the first opening end 141, thereby protecting the operation of the magnetic-electric control component 3. Furthermore, even if soft foreign matter, such as dust, gets trapped at the second opening end 142, the configuration of the flow-guiding portion 13 allows airflow to carry the dust away, preventing blockage at the second opening end 142.

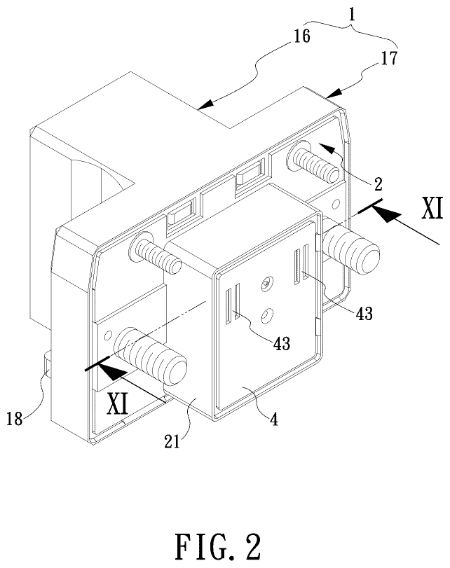

Further, please refer to FIGS. 2, 4, and 5. To allow the outer cover 1 to be assembled with a dedicated terminal base or control panel (not shown), the outer cover 1 further includes a main cover portion 16 and two side cover portions 17 connected to both sides of the main cover portion 16. The outer cover 1 is T-shaped, and two tabs 18 extend from the corners where the main cover portion 16 is connected to the side cover portions 17, respectively. Each of the tabs 18 has a bottom portion recessed with a side groove 181 and a notch 182 positioned around the respective side groove 181. The tabs 18, the side grooves 181, the notches 182 and the pair of openings 132 are interconnected. Each of the side grooves 181 has a bottom surface provided with a locking block 183 protruding from it. Additionally, two locking holes 184 penetrate the tabs 18 and the locking blocks 183 within the tabs 18, respectively. The locking holes 184 are mainly provided for screws to pass through, securing the relay heat dissipation structure to the installation location, such as a terminal base, panel or the like. Moreover, each of the notches 182 further includes an inner opening end 1821, an outer opening end 1822, and a sloped guide surface 1823 connecting the inner opening end 1821 with the outer opening end 1822. The inner opening end 1821 communicates with the groove space of the corresponding side groove 181, while the outer opening end 1822 is located on the outer periphery of the respective tab 18 and communicates with the respective inner opening end 1821. The sloped guide surface 1823 is inclined downward from the end connected to the respective inner opening end 1821 toward the respective outer opening end 1822. According to the aforementioned configuration, the high temperature inside the receiving groove 11 can be discharged through the at least one air convection hole 14, then flow into the recessed space of the air guide groove 131, exit through the pairs of openings 132, and then be conducted into the side grooves 181 of the tabs 18. Further, through the interconnected configuration of the side grooves 181, the notches 182, and the pairs of openings 132, the high temperature from the receiving groove 11 can be discharged to the outside via the notches 182, forming a circulating airflow.

Next, please refer to FIGS. 2, 5, and 11 to 14. Another technical feature of the present invention is the base. On the side of the base 2 opposite the receiving opening 12, a box portion 21 with an opening 211 is formed in a protruding shape. A bottom cover 4 is detachably assembled to the box portion 21, sealing the opening 211. The box portion 21 mainly is provided to house part of the magnetic-electric control component 3 and heat may also accumulate therein. Therefore, on the side of the bottom cover 4 facing the inside of the box portion 21, at least one inner air hole 41 is further provided. Additionally, on the external side of the bottom cover 4, corresponding to the position of the at least one inner air hole 41, at least one outer air hole 42 is provided. The at least one inner air hole 41 and the at least one outer air hole 42 communicate with each other. The aperture of the at least one outer air hole 42 may be larger or smaller than that of the at least one inner air hole 41. Although the receiving groove 11 is used to receive part of the magnetic-electric control component 3, it still communicates with the inside of the box portion 21. Therefore, through the design of the receiving groove 11, the at least one air convection hole 14 can communicate with the inner air hole 41 and the outer air hole 42, forming a convection air space inside the receiving groove 11. Accordingly, any foreign matter can be prevented from clogging the second opening end 142 or the outer air hole 42.

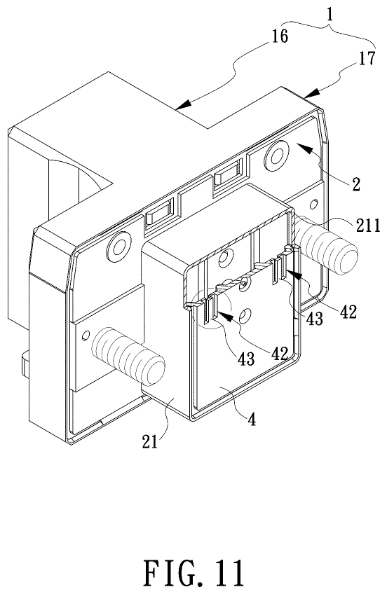

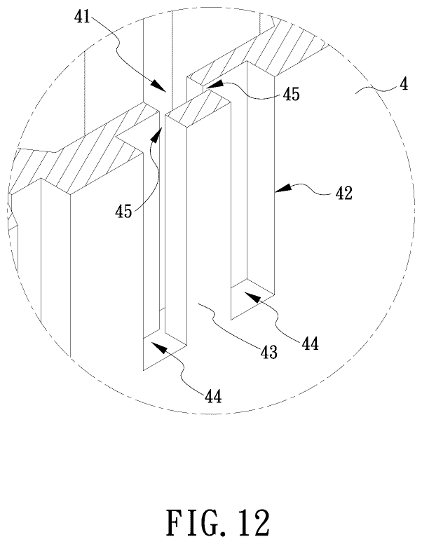

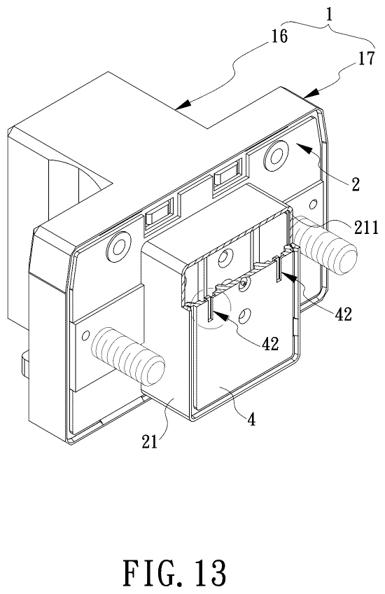

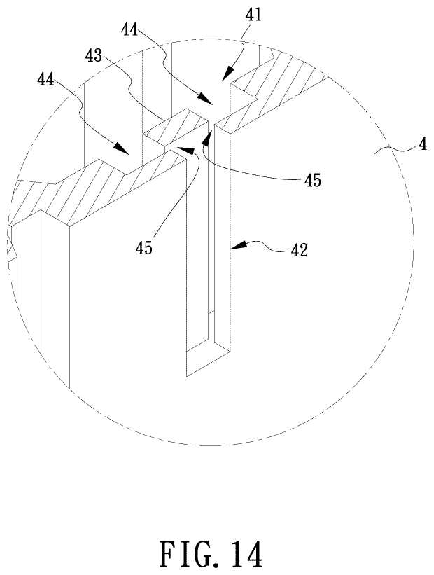

There are two configuration types for the previously mentioned inner air hole 41 and outer air hole 42. As shown in FIGS. 11 and 12, when the aperture of the at least one outer air hole 42 is larger than that of the at least one inner air hole 41, the at least one outer air hole 42 is further provided with a diversion rib 43, which is configured into a long straight plate. The diversion rib 43 divides the at least one outer air hole 42 into two diversion openings 44, and the diversion rib 43 is spaced apart from the at least one inner air hole 41, forming two narrow flow openings 45. Each of the narrow flow openings 45 communicates with the respective diversion opening 44 and the at least one inner air hole 41. Accordingly, with the two diversion openings 44 and the diversion rib 43 to block external foreign matter from entering the box portion 21 with maintaining air convection between the inside and outside of the box portion 21 to keep the box portion 21 at the appropriate temperature. This can ensure stable operation and conductive contact of the magnetic-electric control component 3 inside the box portion 21. In addition to those illustrated in FIGS. 11 and 12, the inner air hole 41 and the outer air hole 42 of the bottom cover 4 can be configured differently, as illustrated in FIGS. 13 and 14. When the aperture of the at least one outer air hole 42 is smaller than that of the at least one inner air hole 41, the diversion rib 43 is positioned at the at least one inner air hole 41, serving as a barrier to block foreign matter, thus achieving the same effect as shown in FIGS. 11 and 12. As seen in the two embodiments above, the diversion rib 43 is used to create a staggered configuration of the inner air hole 41 or the outer air hole 42. Moreover, by dividing the aperture of the at least one inner air hole 41 or the at least one outer air hole 42 into two diversion openings 44 using the diversion rib 43, the aperture size is reduced, effectively blocking objects such as water droplets. Water droplets will not penetrate the diversion openings 44 due to surface tension, thus preventing electrical malfunctions of the components inside the box portion 21 and avoiding internal freezing issues. Furthermore, the configuration of the diversion rib 43 improves manufacturing efficiency for mold makers.

What is claimed is:

1. A relay heat dissipation structure, comprising:
an outer cover with a receiving groove which is recessed from one side thereof and has a receiving opening, wherein any portion on a surface the outer cover is provided with a flow-guiding portion that has at least one air convection hole extending therethrough, directed toward the receiving groove, and communicating with the receiving groove; and
a base, installed on the side of the outer cover having the receiving opening, wherein a magnetic-electric control component is further installed on a side of the base facing the receiving groove;
wherein the flow-guiding portion is configured to allow heat generated by the magnetic-electric control component located within the receiving groove to circulate via the at least one air convection hole, thereby maintaining an operational yield of the magnetic-electric control component.

2. The relay heat dissipation structure as claimed in claim 1, wherein the flow-guiding portion further includes an air guide groove recessed toward the receiving groove; the at least one air convection hole extends through a bottom surface of the air guide groove and communicates with the receiving groove; a pair of openings are formed at both ends of the air guide groove, respectively; and high temperature inside the receiving groove is allowed to be discharged through the air convection hole, flow through the air guide groove, and exit through the pair of openings via circulation and convection.

3. The relay heat dissipation structure as claimed in claim 2, wherein an annular rib is further provided and protrudes from the bottom surface of the air guide groove, corresponding to where the at least one air convection hole is disposed, and is configured to surround an opening of the at least one air convection hole.

4. The relay heat dissipation structure as claimed in claim 3, wherein the air guide groove has a groove height defined as T, and the annular rib has a height defined as D, with T=D or T>D.

5. The relay heat dissipation structure as claimed in claim 4, wherein when T=D, a side guide groove is further recessed in a portion of the annular rib and configured to connect at one end to the at least one air convection hole, and connect at the other end to a groove space of the air guide groove to allow high temperature inside the receiving groove to be discharged through the at least one air convection hole, guided into the air guide groove via the side guide groove and then expelled through the pair of openings.

6. The relay heat dissipation structure as claimed in claim 1, wherein an opening of the at least one air convection hole connecting to the receiving groove is defined as a firs opening end, while another opening of the at least one air convection hole opposite the first opening end is defined as a second opening end; the second opening end has an aperture smaller than that of the first opening end; and the at least one air convection hole has an inner bore that tapers from the first opening end toward the second opening end, forming a conical shape.

7. The relay heat dissipation structure as claimed in claim 2, wherein the outer cover further includes a main cover portion and two side cover portions connected to both sides of the main cover portion; two tabs extend from corners where the main cover portion is connected to the side cover portions, respectively; each of the tabs has a bottom portion recessed with a side groove and a notch positioned around the respective side groove; the tab, the side grooves, the notches and the pair of openings are interconnected; each of the side grooves has a bottom surface provided with a locking block protruding therefrom; and two locking holes penetrate the tabs and the locking blocks within the tabs, respectively; and
each of the notches further includes an inner opening end, an outer opening end, and a sloped guide surface connecting the inner opening end with the outer opening end; the inner opening end communicates with a groove space of the corresponding side groove, while the outer opening end is located on an outer periphery of the respective tab and communicates with the respective inner opening end; and the sloped guide surface is inclined downward from one end connected to the respective inner opening end toward the respective outer opening end.

8. The relay heat dissipation structure as claimed in claim 1, wherein a box portion protrudes from one side of the base opposite the receiving opening and has an opening; a bottom cover is detachably assembled to the box portion, sealing the opening; at least one inner air hole is further provided on one side of the bottom cover facing an inside of the box portion; at least one outer air hole is provided on an external side of the bottom cover, corresponding to where the at least one inner air hole is disposed; the at least one inner air hole and the at least one outer air hole communicate with each other; and the at least one outer air hole has an aperture larger or smaller than that of the at least one inner air hole.

9. The relay heat dissipation structure as claimed in claim 8, wherein when the aperture of the at least one outer air hole is larger than that of the at least one inner air hole, the at least one outer air hole is further provided with a diversion rib that divides the at least one outer air hole into two diversion openings; the diversion rib is spaced apart from the at least one inner air hole, forming two narrow flow openings; and each of the narrow flow openings communicates with the respective diversion opening.

10. The relay heat dissipation structure as claimed in claim 8, wherein when the aperture of the at least one outer air hole is smaller than that of the at least one inner air hole, the at least one inner air hole is further provided with a diversion rib that divides the at least one inner air hole into two diversion openings; the diversion rib is spaced apart from the at least one outer air hole, forming two narrow flow openings; and each of the narrow flow openings communicates with the respective diversion opening.
